(19) United States
(12) Patent Application Publication
(10) Pub. No.: US 2025/0323426 A1
(43) Pub. Date: Oct. 16, 2025

(54) BASE STATION ANTENNAS WITH RADIATING ELEMENTS HAVING BENT FEED STALKS AND SIDE FEED

(71) Applicant: Outdoor Wireless Networks LLC, Claremont, NC (US)

(72) Inventors: Haifeng Li, Richardson, TX (US); Peter J. Bisiules, LaGrange Park, IL (US)

(21) Appl. No.: 19/036,523

(22) Filed: Jan. 24, 2025

Related U.S. Application Data
(60) Provisional application No. 63/633,167, filed on Apr. 12, 2024.

(51) Int. Cl. H01Q 21/06; H01Q 1/24; H01Q 15/00; H01Q 15/14

(52) U.S. Cl. CPC H01Q 21/062; H01Q 1/246; H01Q 15/0013; H01Q 15/14

(57) ABSTRACT

Radiating elements of first and second linear arrays of radiating elements have respective feed stalks that project laterally inward from side feeds, then bend at a 90 degree angle to project forward and provide a balanced dipole arm.

### RELATED APPLICATIONS

This patent application claims priority to and the benefit of U.S. Provisional Patent Application Ser. No. 63/633,167, filed Apr. 12, 2024, the contents of which are hereby incorporated by reference as if recited in full herein.

### BACKGROUND

The present invention generally relates to radio communications and, more particularly, to base station antennas for cellular communications systems.

Cellular communications systems are well known in the art. In a typical cellular communications system, a geographic area is divided into a series of regions that are referred to as “cells,” and each cell is served by a base station. The base station may include baseband equipment, radios and base station antennas that are configured to provide two-way radio frequency (“RF”) communications with subscribers that are positioned throughout the cell. In many cases, the cell may be divided into a plurality of “sectors,” and separate base station antennas provide coverage to each of the sectors. The antennas are often mounted on a tower, with the radiation beam (“antenna beam”) that is generated by each antenna directed outwardly to serve a respective sector. Typically, a base station antenna includes one or more phase-controlled arrays of radiating elements, with the radiating elements arranged in one or more vertical columns when the antenna is mounted for use. Herein, “vertical” refers to a direction that is perpendicular to the horizontal plane that is defined by the horizon. Reference will also be made to the azimuth plane, which is a horizontal plane that bisects the base station antenna, and to the elevation plane, which is a plane extending along the boresight pointing direction of the antenna that is perpendicular to the azimuth plane.

A common base station configuration is the “three sector” configuration in which a cell is divided into three 120° sectors in the azimuth plane. A base station antenna is provided for each sector. In a three-sector configuration, the antenna beams generated by each base station antenna typically have a Half Power Beamwidth (“HPBW”) in the azimuth plane of about 65° so that each antenna beam provides good coverage throughout a 120° sector. Three such base station antennas provide full 360° coverage in the azimuth plane. Typically, each base station antenna will include one or more so-called “linear arrays” of radiating elements that includes a plurality of radiating elements that are arranged in a generally vertically-extending column. Each radiating element may have an azimuth HPBW of approximately 65° so that the antenna beam generated by the linear array will have a HPBW of about 65° in the azimuth plane. By providing a phase-controlled column of radiating elements extending along the elevation plane, the HPBW of the antenna beam in the elevation plane may be narrowed to be significantly less than 65°, with the amount of narrowing increasing with the length of the column in the vertical direction.

As the volume of cellular traffic has grown, cellular operators have added new cellular services in a variety of new frequency bands. When these new services are introduced, the existing “legacy” services typically must be maintained to support legacy mobile devices. In some cases, it may be possible to use linear arrays of so-called “wide-band” radiating elements to support service in the new frequency bands. In other cases, however, it may be necessary to deploy additional linear arrays (or multi-column arrays) of radiating elements to support service in the new frequency bands. Due to local zoning ordinances and/or weight and wind loading constraints, there is often a limit as to the number of base station antennas that can be deployed at a given base station. Thus, to reduce the number of antennas, many operators deploy so-called “multiband” base station antennas that include multiple linear arrays of radiating elements that communicate in different frequency bands to support multiple different cellular services. Additionally, with the introduction of fifth generation (5G) cellular services, multi-column arrays of radiating elements are being added to base station antennas that can support beamforming and/or massive multi-input-multi-output (“MIMO”) 5G services.

One multi-band base station antenna that is currently of interest includes two linear arrays of “low-band” radiating elements that are used to provide service in some or all of the 617-960 MHz frequency band, as well as a massive MIMO array of “high-band” radiating elements that operate in, for example, some or all of the 2.5-2.7 GHz frequency band, the 3.4-3.8 GHz frequency band, or the 5.1-5.8 GHz frequency band. Massive MIMO arrays typically have at least four columns of radiating elements, and as many as thirty-two columns of radiating elements. Most proposed implementations include eight columns of radiating elements (or vertically stacked sets of eight column arrays to obtain sixteen or thirty-two column arrays).

Cellular operators often have strict limits on allowable widths for different types of base station antenna. For example, the base station antenna can have a maximal width of about 500 mm, in some embodiments to meet commercially acceptable configurations. The base station antenna can be challenging to implement in a commercially acceptable manner because achieving a 65° azimuth HPBW antenna beam in the low-band typically requires low-band radiating elements that are, for example, about 200 mm (or more) wide.

### SUMMARY

Embodiments of the invention provide base station antennas with bent feed stalks coupled at one end to side support segments and/or side feeds and at the other end(s) to one or more radiating elements and configured to position the radiating elements a distance away from left or right side walls of the base station antenna.

The bent feed stalks can be configured so that there is a single feed stalk for a single radiating element with the single feed stalk providing the radiofrequency (RF) signal and ground electrical paths for cross-polarized dipole arms of the single radiating element.

A feed stalk can feed first and second dual polarized radiating elements.

The feed stalk can be mounted to a side support segment.

Feed boards for dual polarized radiating elements can be attached to side support segments, both of which can be perpendicular to a printed circuit board providing dipole radiators of the dual polarized radiating elements.

Embodiments of the invention are directed to a base station antenna that includes: a longitudinally-extending support; a plurality of side support segments that are longitudinally spaced apart and that extend forwardly from the longitudinally-extending support; and a plurality of radiating elements, at least some of which are mounted to one or more of the plurality of side support segments.

The longitudinally-extending support can be provided as a first longitudinally extending support positioned to extend along a first side wall of a housing enclosing the plurality of radiating elements and a second longitudinally extending support-extending support positioned to extend along a laterally spaced apart second side wall of the housing.

A plurality of the side support segments can each have a wall that is perpendicular to a reflector or frequency selective surface positioned behind the plurality of radiating elements.

The plurality of side support segments can be attached to the longitudinally-extending support.

The base station antenna can further include a plurality of feed boards arranged so that at least one feed board of the plurality of feed boards is parallel to and mounted to at least one of the plurality of side support segments.

The plurality of radiating elements can include a first vertically-extending column of first radiating elements, at least some of which can be mounted to one of the plurality of side support segments or to more than one but a subset of the plurality of side support segments.

The plurality of side support segments can be provided as a plurality of first side support segments extending along the first side wall of the housing and a plurality of second side support segments extending along the second side wall of the housing. The plurality of radiating elements can include a first vertically-extending column of first radiating elements, at least some of which can be mounted to one or more of the first side support segments, and also a second vertically-extending column of first radiating elements, at least some of which can be mounted to one or more of the second side support segments.

A plurality of radiating elements in the base station antenna can each have a feed stalk. The feed stalk can have a first leg and a second leg. The first leg can attach to at least one of the side support segments and extend laterally inward from the at least one side support segment. The second leg can be orthogonal to the first leg and can extend forward of the first leg to attach to dipole radiators of a corresponding radiating element at a position in the base station antenna that is forward of the first leg.

The plurality of radiating elements can have a printed circuit board providing first and second dipole radiators and the printed circuit board can be perpendicular to the side support segments.

The longitudinally-extending support can have a channel that extends in a longitudinal direction. The base station antenna can further include feed cables that extend in the channel.

The longitudinally-extending support can have an outer wall surrounding the channel. The outer wall can have a plurality of apertures that are longitudinally spaced apart. At least one aperture of the plurality of apertures of the outer wall can be adjacent at least one of the side support segments. At least one feed cable of the feed cables in the channel and is routed out of one of the plurality of apertures to extend forward of the longitudinally-extending support and can connect to at least one radiating element of the plurality of radiating elements.

At least one feed cable can be connected to a feed board held by one or more of the side support segments. The feed board can be perpendicular to a primary reflector coupled to the longitudinally-extending support.

The feed cables can be coaxial feed cables. An outer conductor of the coaxial feed cables can be electrically grounded to the longitudinally-extending support.

The base station antenna can further include: a substrate in the housing providing a frequency selective surface residing behind at least some of the plurality of radiating elements and a primary reflector in the housing attached to the longitudinally-extending support.

The substrate can include at least one matching layer or the substrate can be adjacent at least one matching layer.

Neighboring pairs of at least some of the side support segments can be spaced apart a distance greater than a length of the side support segments. The length is measured in a longitudinal direction of the base station antenna.

The plurality of radiating elements can include cross-dipole radiating elements. Each cross-dipole radiating element has first and second dipole radiators that can be provided by a printed circuit board. A feed stalk can be attached to the first and second dipole radiators and reside behind the printed circuit board. The feed stalk can have a first leg that extends laterally inward from one or more of the side support segments, then turns 90 degrees to project forward from the first leg, adjacent the printed circuit board.

The feed stalk can have a single feed stalk body that provides both a ground path and microstrip transmission line.

At least some of the plurality of radiating elements can each have a feed stalk that has a first leg that attaches to at least one of the side support segments the first leg extends laterally inward and merges into first and second intermediate segments that extend longitudinally in opposing directions then merge into a respective second leg of the feed stalk. The respective second leg of the feed stalk is orthogonal to the first leg and extends in a front to back direction of the base station antenna, forward of the first leg to attach to a respective radiating element forward of the first leg.

The base station antenna can further include at least some feed boards that are elongate in a longitudinal direction of the base station antenna and can be mounted to a subset of the plurality of side support segments and that are coupled to one or more radiating element of the plurality of radiating elements.

One feed stalk of one radiating element of the plurality of radiating elements can be mounted to one side support segment.

Feed boards can be coupled to the side support segments and the feed boards can be perpendicular to a primary surface of a reflector and/or frequency selective surface behind the plurality of radiating elements.

The base station antenna can further include a feed stalk that feeds first and second dual polarized radiating elements of the plurality of radiating elements.

The feed stalk can be mounted to one or more of the side support segments.

The first and second dual polarized radiating elements can operate in different frequency ranges.

The plurality of radiating elements can further include: a first vertically-extending column of second radiating elements, at least some of which can be mounted to one or more of the first side support segments; a second vertically-extending column of second radiating elements, at least some of which can be mounted to one or more of the second side support segments, a third vertically-extending column of the second radiating elements, at least some of which can e mounted to one or more of the first side support segments; and a fourth vertically-extending column of the second radiating elements, at least some of which can be mounted to one or more of the second side support segments.

At least some of the second radiating elements can reside closer to the first side support segments than the first radiating elements that are mounted to one or more of the first side support segments.

A second radiating element of the first vertically-extending column of second radiating elements and a second radiating element of the second vertically-extending column of second radiating elements can share a feed stalk that extends laterally inward from the one or more of the first side support segments. A second radiating element of the third column of second radiating elements and a second radiating element of the fourth column of second radiating elements can share a feed stalk that extends laterally inward from one or more of the second side support segments.

A shared feed stalk can extend adjacent a feed stalk of a first radiating element of the first column of the first radiating elements or a feed stalk of a first radiating element of the second column of the first radiating elements. The feed stalk of the first radiating element can have a first leg that extends laterally inward, parallel to a first leg of the shared feed stalk.

A second radiating element of the first vertically-extending column of second radiating elements, a second radiating element of the second vertically-extending column of second radiating elements and a first radiating element of the first vertically-extending column of first radiating elements can share a feed stalk that that has a first leg that extends laterally inward from the one or more of the first side support segments.

A second radiating element of the third vertically-extending column of second radiating elements, a second radiating element of the fourth vertically-extending column of the second radiating elements and a first radiating element of the second vertically-extending column of first radiating elements can share a feed stalk that has a first leg that extends laterally inward from one or more of the second side support segments.

Two adjacent second radiating elements of the first column of second radiating elements and two adjacent second radiating elements of the second column of second radiating elements and a first radiating element of the first column of first radiating elements can share a feed stalk that can have a first leg that extends laterally inward from the one or more of the first side support segments.

Two adjacent second radiating elements of the third column of second radiating elements and the fourth column of second radiating elements and a first radiating element of the second column of first radiating elements can share a feed stalk that can have a first leg that extends laterally inward from one or more of the second side support segments.

The plurality of radiating elements can include a first column of first radiating elements and a second column of first radiating elements. The base station antenna can further include a multiple column array of radiating elements that can be positioned so that at least some of the radiating elements of the multiple column array are laterally between and behind and the first column of first radiating elements and the second column of first radiating elements.

The first radiating elements of the first column and the second column of first radiating elements can be low-band radiating elements, and the radiating elements of the multiple column array can be higher-band radiating elements than the low-band radiating elements.

At least some of the radiating elements can be cross-dipole radiating elements with first and second dipole radiators. The first and second dipole radiators can be provided by a respective printed circuit board. A feed stalk can be coupled to each of the first radiating elements with a front end portion that is perpendicular to the printed circuit board and the feed stalk can have a laterally extending leg that is behind the front end portion and that couples to one or more of the side support segments.

The first dipole radiator can include a first dipole arm that extends in a first direction and a second dipole arm that extends in a second direction, and the second dipole radiator can include a third dipole arm that extends in the third direction and a fourth dipole arm that extends in a fourth direction.

The first dipole radiator can be configured to transmit RF radiation having slant −45° polarization, and the second dipole radiator can be configured to transmit RF radiation having slant +45° polarization.

Embodiments of the present application are directed to a base station antenna that includes: a feed stalk that has a first leg that projects laterally inward a first distance and feeds first and second dipole radiators of a first radiating element as well as third and fourth dipole radiators of a second radiating element.

The first leg can merge into a T-junction with each side of the T having a second leg coupled to two of the dipole radiators.

The first radiating element can be a low-band radiating element and the second radiating element is a mid-band radiating element.

The first and second radiating elements can both be low-band cross-dipole radiating elements.

The first leg can be attached to at least two second legs that are spaced apart, and a first of the at least two second legs can be attached to the first and second dipole radiators and a second of the at least two second legs can be attached to the third and fourth dipole radiators.

The feed stalk can be configured to also feed fifth and six dipole radiators of a third radiating element. The first leg can be attached to at least three second legs that are spaced apart, a first of the three second legs can be attached to the first and second dipole radiators and a second of the three second legs can be attached to the third and fourth dipole radiators, and a third of the three second legs can be attached to the fifth and sixth dipole radiators.

The first leg can be coupled to a side support segment or side support segments residing adjacent a side wall of the base station antenna.

Embodiments of the invention are directed to a base station antenna that includes: a plurality of side support segments that are longitudinally spaced apart and coupled to a longitudinally extending support; a reflector; a plurality of radiating elements, at least some of which reside in front of the reflector; and feed boards that are coupled to one or more of the side support segments and feed the plurality of radiating elements. The feed boards are perpendicular to a primary surface of the reflector and/or a primary surface of a frequency selective surface behind the plurality of radiating elements.

The base station antenna can further include a feed stalk that extends laterally inward from one of the feed boards and can feed first and second dual polarized radiating elements of the plurality of radiating elements.

The feed stalk can be mounted to one or more of the side support segments.

The feed stalk can feed first and second dual polarized radiating elements that operate in different frequency ranges.

It should be noted that various aspects of the present disclosure described for one embodiment may be included in other different embodiments, even though specific description is not made for the other different embodiments. In other words, all the embodiments and/or features of any embodiment may be combined in any manner and/or combination, as long as they are not contradictory to each other.

### BRIEF DESCRIPTION OF THE DRAWINGS

FIG. 1 is a front, side perspective view of a prior art base station antenna (also sometimes referred to as a “passive antenna”).

FIG. 2 is a partial lateral section view of components of a portion of a base station antenna according to embodiments of the present invention.

FIG. 3 is a front, side perspective view of the components shown in FIG. 2 (shown without the dipole supports).

FIG. 4 is a partial lateral section view of the components shown in FIG. 3.

FIG. 5 is an enlarged side view of a portion of the components shown in FIG. 3 according to embodiments of the present invention.

FIG. 6 is a front, side perspective view of another embodiment of some components of a base station antenna providing a 1:2 feed board configuration according to embodiments of the present invention.

FIG. 7 is a partial lateral section view of the components shown in FIG. 6.

FIG. 8 is an enlarged side view of the components shown in FIG. 6 according to embodiments of the present invention.

FIG. 9 is a front perspective view of components of a portion of a base station antenna illustrating another layout of and signal feed structure of the feed stalks and radiating elements according to embodiments of the present invention.

FIG. 10 is a front perspective view of an example layout of a multi-band antenna arrangement according to embodiments of the present invention.

FIG. 11 is an enlarged view of one side portion of the components shown in FIG. 3.

FIG. 12 is a front perspective view of another embodiment of a multi-band antenna arrangement according to embodiments of the present invention.

FIG. 13 is a front perspective view of another embodiment of a multi-band antenna arrangement according to embodiments of the present invention.

FIG. 14 is a front perspective view of another embodiment of a multi-band antenna arrangement according to embodiments of the present invention.

FIG. 15A is a front perspective, partially transparent simplified view of a portion of a base station antenna according to embodiments of the present invention.

FIG. 15B is a simplified side schematic section view of an example base station antenna and active antenna unit/module according to embodiments of the present invention.

FIG. 16 is an enlarged side perspective view of an internal portion of a base station antenna illustrating the longitudinally-extending support(s) electrically and physically connected to a primary reflector in the base station antenna to provide a common electrical ground.

### DETAILED DESCRIPTION

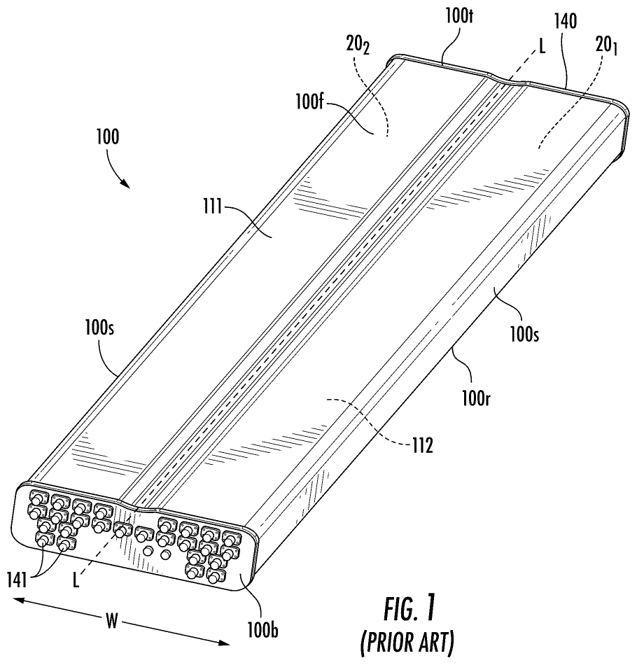

Referring to FIG. 1, a prior art base station antenna 100 is shown. The base station antenna 100 can include a first linear array 20-1 of radiating elements and a second linear array 20-2 of radiating elements. The base station antenna 100 can be referred to as a “passive antenna” and has a front 100f with a radome 111, a rear 100r and an internal reflector 112. As is well known to those of skill in the art, the radiating elements face the radome 111 at the front 100f of the base station antenna 100. The radiating elements of the first linear array 20-1 are arranged in a first column and the radiating elements of the second linear array 20-2 are arranged in a second column that is laterally spaced apart from the first column. The first and second linear arrays 20-1, 20-2 can be low-band linear arrays. The base station antenna 10 has a longitudinal dimension L which is vertically oriented when mounted to a support structure such as a pole or other device and can have a maximal width W that is about 500 mm, in some embodiments. However, other widths may be used. The base station antenna 100 has right and left side walls between and joining the front 100f and rear 100r, as well as a top 100t with an end cap 140 and a bottom 100b with RF ports 141. A one piece tubular radome may form the front 100f, rear 100r and side walls 100s of the base station antenna 100 in some embodiments.

In the past, angled feed stalks for the radiating elements of the linear arrays 20-1, 20-2 have been proposed which can position dipoles of such radiating elements relatively close to side walls. See, U.S. Pat. No. 11,652,300, which is incorporated by reference as if recited in full herein. Embodiments of the present inventive concept provide improved structures that can, inter alia, position dipoles further away from such side walls which can provide improved pattern performance.

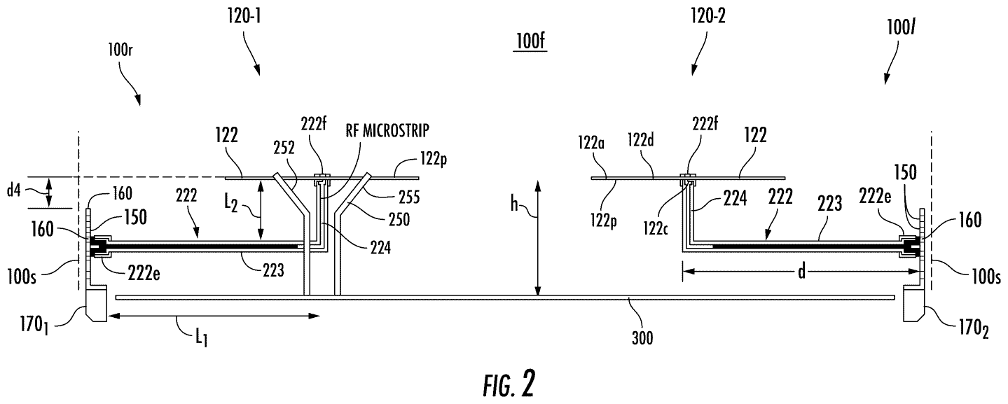

Turning now to FIGS. 2-4, embodiments of the present invention provide feed stalks 222 that extend laterally inward a distance then turn upward to position dipole arms 122d of the radiating elements 122 forward of the feed stalk 222 and at a lateral distance “d” from the closest side wall 100s of the base station antenna 100. The distance “d” can be two to five times the height of the side wall 100s. The distance “d” depends on the width of the antenna. In a side-by-side antenna design, the column spacing of the radiating arm can be at about 0.75 wavelength of the working band. Thus “d” is the distance between the radiating arm and the side of antenna, so it will be larger in a wider housing antenna and smaller in a narrow housing antenna.

Placing the radiating elements 122 laterally inward, away from the side wall 100s, can generate less side radiation by the radiating elements 122, improving passive intermodulation (PIM) performance (reducing PIM, relative to positions closer to the side walls) and can provide improved antenna performance for respective working band of the radiating elements 122. The radiating arm is a primary or main radiation feature of the dipole, so when it extends laterally inward, the side can provide enough reflector for the element reflection, the radiation from the front side to back side is weaker relative to when the radiating arm is closer to the side. The less radiation to the back side will lead to a lesser PIM source being activated and the PIM level will increase. For the antenna pattern performance, the arm has enough reflection at each side and can cause the pattern to be more symmetrical and less radiation to the back side will generate more directivity for the front side.

The angled configuration of the feed stalk can be descriptively referred to as “bent” or as having a “bend” even though structurally no bend is required. For example, the feed stalk 222 can be formed to have the forwardly angled configuration without physically bending the substrate providing the feed stalk shape. A feed stalk formed of a printed circuit board or sheet metal, for example, can be stamped or cut or otherwise formed from one or more pieces of substrate, such as metal or a PCB, and oriented when assembled to have a “bend”, meaning that the forwardmost segment projects forward at an angle relative to the segment projecting laterally inward to couple to the radiating element 122 at the forwardly located segment.

The radiating elements 122 can be provided as first and second linear arrays 120-1, 120-2 of radiating elements 122. The feed stalk 222 can be configured so that the radiating element 122 is positioned at a height dimension “h” that is forward of a substrate 300. As will be discussed in further detail below, the substrate 300 may comprise a frequency selective surface in some embodiments. The feed stalk 222 can mount the dipole arms 122d at an appropriate distance “h” in front of the substrate 300 and/or a reflector of base station antenna 100, which is often approximately 3/16 to ¼ of an operating wavelength of the radiating element 122. The “operating wavelength” refers to the wavelength corresponding to the center frequency of the operating frequency band of the radiating element 122.

The feed stalk 222 can be configured to position the radiating element 122 forward of the side support segments 160 a distance d4. By moving the radiating arm inside (away from the side wall), the side walls can have less restrictive height, in a front to back direction, over conventional designs. In a conventional design, it was found that when the arm is close to the side wall, the height of the side wall (front to back direction) can hurt the pattern, because the wall can be metal and easy to couple and obtain current from the arm. In contrast, in embodiments of the present inventive concept, any height of the wall can be used, because the arm is further away of the side wall and less radiation couples to the side wall.

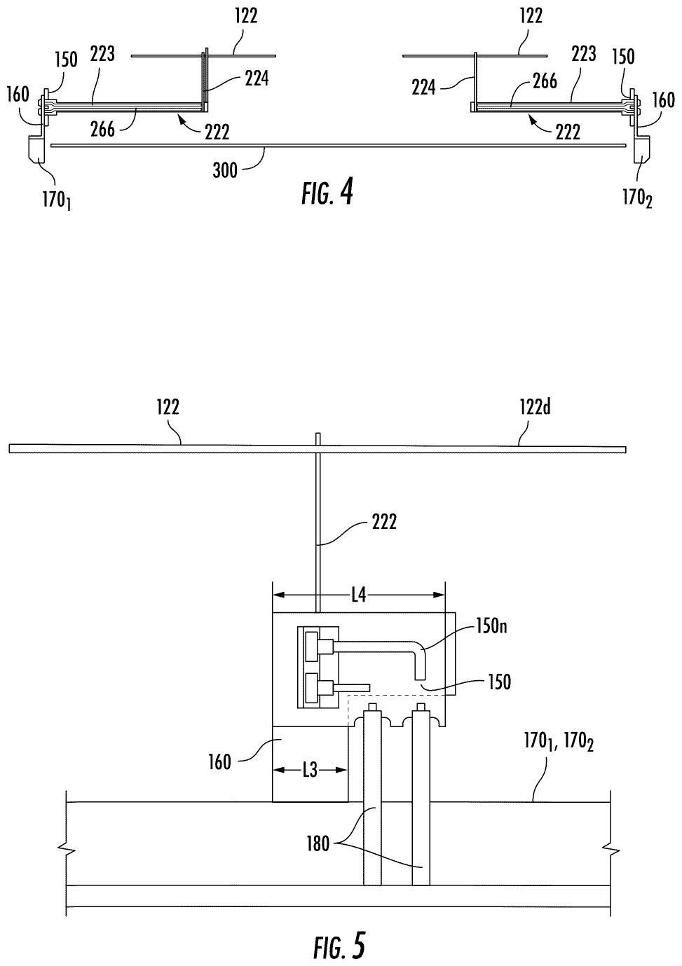

In some embodiments, one feed stalk 222 can be coupled to a corresponding one feed board 150 which can be mounted to one or more side support segments 160 so that the feed board 150 is perpendicular to the feed stalk 222 thereat. The feed board 150 can be parallel to the support 160. Referring to FIG. 5, the feed board 150 can be positioned to face the feed stalk 222 and may reside on an inner facing surface of the side support segment 160 so that the feed board is closer to the feed stalk 222 than the side support segment 160. However, other mounting configurations with respect to the support 160 may be used, e.g., the feed board 150 may be positioned so that the support is closer to the feed stalk 222.

In some embodiments, a plurality of feed stalks 222 on one side (e.g., a left side) of the base station antenna 100 can be coupled to a single feed board 150 and a plurality of feed stalks 222 on the other side (e.g., the right side) of the base station antenna 100 can be coupled to a different single feed board 150. For example, two longitudinally adjacent/neighboring feed stalks 222 on one side of the base station antenna 100 can couple to one feed board 150 and one of the side support segments 160.

The side support segments 160 may be provided as an FSS or solid metal structure or other material of sufficient structural rigidity to provide the mounting support for the respective radiating elements 122.

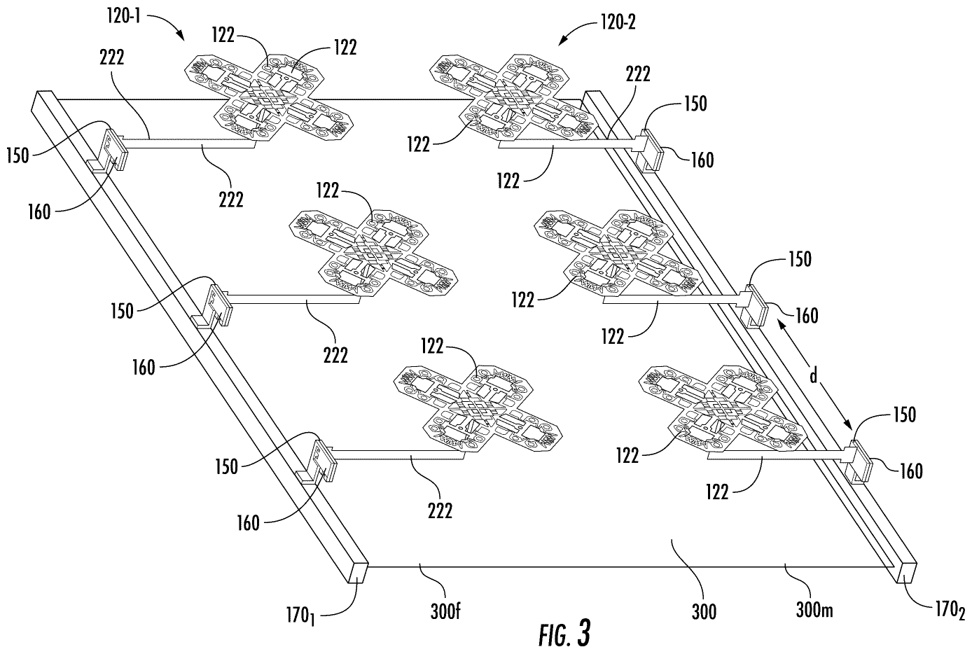

Referring to FIGS. 3 and 5, for example, the side support segments 160 can have a length “L₃” in the longitudinal direction of the antenna 100 that is in a range of about 0.1 inches to about 5 inches, such as 0.1 inches, 0.2 inches, 0.3 inches, 0.4 inches, 0.5 inches, 0.6 inches, 0.7 inches, 0.8 inches, 0.9 inches, 1 inch, 1.25 inches, 1.5 inches, 1.75 inches, 2 inches, 2.25 inches, 2.5 inches, 2.75 inches, 3 inches, 3.25 inches, 3.5 inches, 3.75 inches, 4 inches, 4.25 inches, 4.5 inches, 4.75 inches or about 5 inches. Different side support segments 160 can have different lengths. All or a majority of the side support segments 160 can have a common length L₃. This length La can depends on the size of the feed board 150, if the feed board 150 is longer (longitudinal direction), the length La can be longer. The side support segments 160 can be metal or plastic or metal and plastic.

Neighboring pairs of at least some of the support segments 160 on each side of the base station antenna, e.g, on each longitudinally-extending support 170, can be spaced apart a distance greater than a length L₃ of the support segments 160, measured in a longitudinal direction of the housing 100h of the base station antenna 100. In some embodiments, there can be four to twelve side support segments 160 on each longitudinally-extending support 170. In some embodiments, each longitudinally-extending support 170 can be provided as a rail, frame segment or other support member.

In some embodiments, a longitudinally-extending support 170 and side support segments 160 can be monolithically formed as an integral unit. In some embodiments, a longitudinally extending support 170 and corresponding side support segments 160 can be provided as separate cooperating pieces (as shown).

In some embodiments, a single longitudinally extending support 170 can be used to support a single low band array 220-1 in each of two side by side mounted passive antennas, optionally with an active antenna module 110 positioned to extend behind both.

In some embodiments, no feed boards 150 are required but where feed boards 150 are used, the feed boards 150 can be mounted to a respective one or more feed stalk 222 and the feed boards 150 can be attached to one or more side support segments 160.

The feed boards 150 can have a length “L₄” and La can be the same or greater than L₃, typically at least 20% greater in length. In some embodiments, La is greater than L₃ but less than five times greater in length than L₃. La can depend on the design of the feed board 150. If the feed board 150 uses a cable feed, La is typically greater than L₃. If the feed board 150 extends to the rail and uses other kinds of feeding configurations, then L₄ may equal to L₃.

The feed boards 150 can be capacitively or galvanically electrically coupled to a corresponding side support segment 160 in some embodiments. The side support segments 160 can be capacitively or galvanically (soldered or screwed or otherwise directly or indirectly attached) to be electrically coupled (electrically grounded) to a closest one of the longitudinally-extending supports 1701, 1702. The longitudinally-extending supports 1701, 1702 can be capacitively or galvanically coupled to a primary reflector 400 (FIG. 16) in the base station antenna housing 100h, typically at a location below the substrate 300, via direct or indirect (screw) attachment 1400. Thus, the feed boards 150 can be at a common ground with the primary reflector 400. The side support segments 160 can be metal or plastic. If the side support segments 160 are plastic, the feed boards 150 are not electrically coupled to the side support segments 160.

The radiating elements 122 and feed stalks 222 can be electrically decoupled from, not grounded or connected to, the underlying substrate 300. As discussed above, the substrate 300 may be a FSS (frequency selective surface) that is mounted within the housing enclosing the radiating elements 122 and positioned behind the radiating elements 122.

Referring to FIGS. 5 and 11, the feed boards 150 can have an electrical feed network 150n and can be coupled to (coaxial) feed cables 180. The feed network 150n can provide RF transmission (signal) and ground electrical paths that couple the center conductor and ground conductor of each feed cable to a respective one of the dipole radiators of the radiating elements 122.

The feed cables 180 from each feed board 150 can be routed rearward, behind the feed boards 150 into apertures 170a in an outer wall of the adjacent longitudinally-extending support 170 (one of the right or left side longitudinally-extending support 1701, 1702), then longitudinally inside a channel 172 provided by the corresponding longitudinally-extending support 170 along the longitudinal direction L of the base station antenna to the RF ports 140 (FIG. 1).

The feed cables 180 can be routed directly from a respective longitudinally-extending support 170 to the corresponding feed board 150 and soldered or otherwise connected to that feed board 150. Advantageously, this configuration can eliminate the electrical current that may be present on (e.g., an outer conductor of) the feed cables 180 by grounding to the longitudinally-extending support 170 and enclosing at least a major portion of a length of the feed cables 180 inside the (grounded longitudinally-extending support) channel 172.

Referring again to FIG. 2, each feed stalk 222 can be configured to extend laterally inward and then project forward to position a forward most (first) end 222f closer to the front 100f of the base station antenna than the (second) end 222e that is adjacent the side wall 100s. The feed stalks 222 can have a first leg 223 that merges into a second leg 224. The first leg 223 can have a length “L₁” that is greater than the length “L₂” of the second leg 224. The second leg 224 can be perpendicular to the first leg 223. The first leg 223 can have a greater width (in the Z direction and/or Y direction) than the second leg 224.

Turning again to FIG. 2, the dipole arms 122d of a respective radiating element 122 can be supported, at least in part, by a dipole support structure 250. The dipole support structure 250 can be mounted to a substrate 300. The substrate 300 may comprise, for example, a matching layer and/or a frequency selective surface (FSS). In some embodiments, the dipole support structure 250 may include a plurality of support arms 252, one for each of four dipole arms 122a of the dipole 122d with the second leg 224 of the feed stalk 222 centered between the support arms 252, typically aligned with the center 122c of the dipole 122d.

The radiating element 122 can provide a balanced arm structure. The dipole radiator arms 122a can have a cumulative laterally extending width and the second leg 224 can be substantially centered with respect to the center 122c of the radiating element/printed circuit board 122p forming same. The term “balanced arm structure” refers to a symmetrical arm structure with four sides of the same structure forming the dipole radiator arm 122a.

The substrate 300 can comprise a frequency selective surface (FSS) 300f that can reside behind at least some radiating elements and can selectively reject some frequency bands and permit other frequency bands to pass therethrough by including the frequency selective surface and/or substrate to operate as a type of “spatial filter”. See, also., Ben A. Munk, Frequency Selective Surfaces: Theory and Design, ISBN: 978-0-471-37047-5; DOI: 10.1002/0471723770; April 2000, Copyright © 2000 John Wiley & Sons, Inc. the contents of which are hereby incorporated by reference as if recited in full herein.

The FSS 300f can be implemented, for example, using one or more printed circuit boards (flex or rigid), as one or more stamped metal grids or as metallization patterns formed on a dielectric substrate. The FSS 300f may have a unit cell structure and may be configured to reject and/or reflect RF radiation in the low-band frequency range or both the low-band and mid-band frequency ranges while passing RF radiation in a high band frequency range.

In some embodiments, the substrate 300 can include at least one matching layer 300m and a frequency selective surface (FSS) 300f that extend laterally and longitudinally.

The FSS 300f can be sandwiched between matching layers or the matching layer may be on a front side or a rear side of the FSS 300f. The matching layer 300m can be a film or other material that is overlaid on the FSS 300f that is configured to reduce reflections of RF energy emitted by an array of radiating elements mounted behind the FSS 300f. Further discussions of example matching layers 300m and FSSs 300f can be found in U.S. patent application Ser. No. 17/787,619, filed Mar. 14, 2022, with a 35 USC § 371 date of Mar. 9, 2023, the contents of which are hereby incorporated by reference as if recited in full herein.

The substrate 300 can reside between the longitudinally-extending supports 1701, 1702, behind the feed stalks 222, and may be mounted to the side longitudinally-extending supports 1701, 1702.

The radiating elements 122 can comprise a printed circuit board (PCB) 122p which can be configured to provide cross-polarized dipole arms 122d, in some embodiments. The radiating element PCB 122p can be perpendicular to side walls 100s, side support segments 160 and/or feed boards 150. Sheet metal dipole arms may be used in other embodiments.

The RF transmission line 266 on the feed stalk 222 is used to pass RF signals between the feed board 150 and dipole arms 122d. The RF transmission line 266 can be provided by a microstrip transmission line. The RF transmission line 266 can be coupled to the feed network 150n on the feed board 150, which can be coupled to the feed cable(s) 180. The feed cables 180 can be coaxial cables.

The feed stalk 222, for at least some of the radiating elements 122, can be a single feed stalk instead of conventional multiple feed stalks that connect to ground and signal connectors of one cross-dipole radiating element. See, U.S. patent application Ser. No. 18/250,556, filed Apr. 26, 2023, for further discussion of example configurations of dual-polarized radiating elements having a single feed stalk, the contents of which are hereby incorporated by reference as if recited in full herein. The single feed stalk configuration can occupy less physical space and scatter less RF energy emitted by an array of radiating elements that is mounted behind the substrate 300 than the (larger) multiple feed stalk designs, in some embodiments.

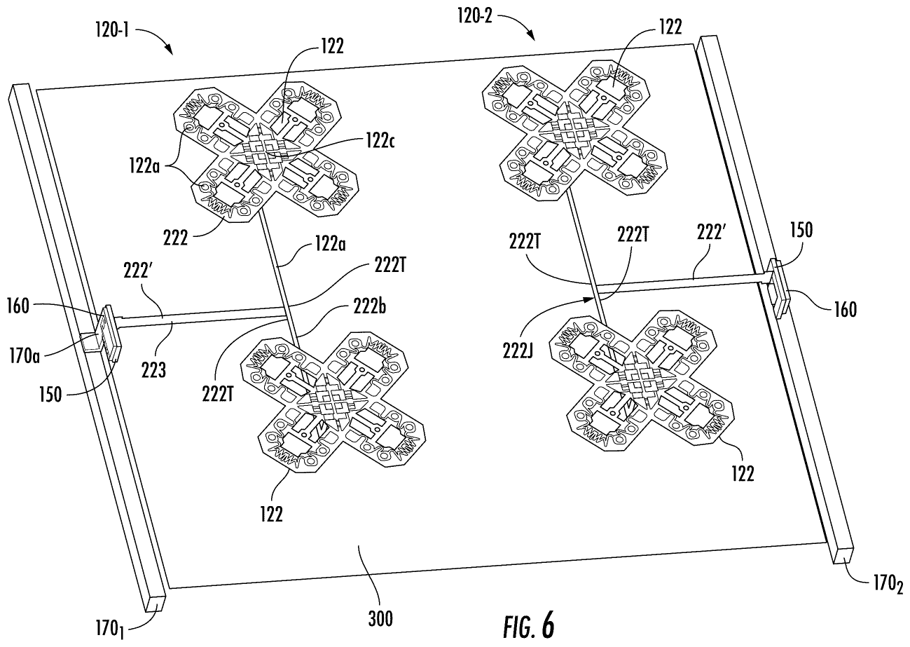

FIGS. 3-6 illustrate a 1:1 configuration whereby each feed board 150 is coupled to a single radiating element 122. FIGS. 6-7 illustrate a 1:2 configuration whereby one feed board 150 feeds two radiating elements 122 via a single feed stalk 222′ that extends from the feed board 150 to a junction 222J where the first laterally inward extending segment 223 of the feed stalk 222′ merges into a first feed stalk segment 222a and a second feed stalk segment 222b.

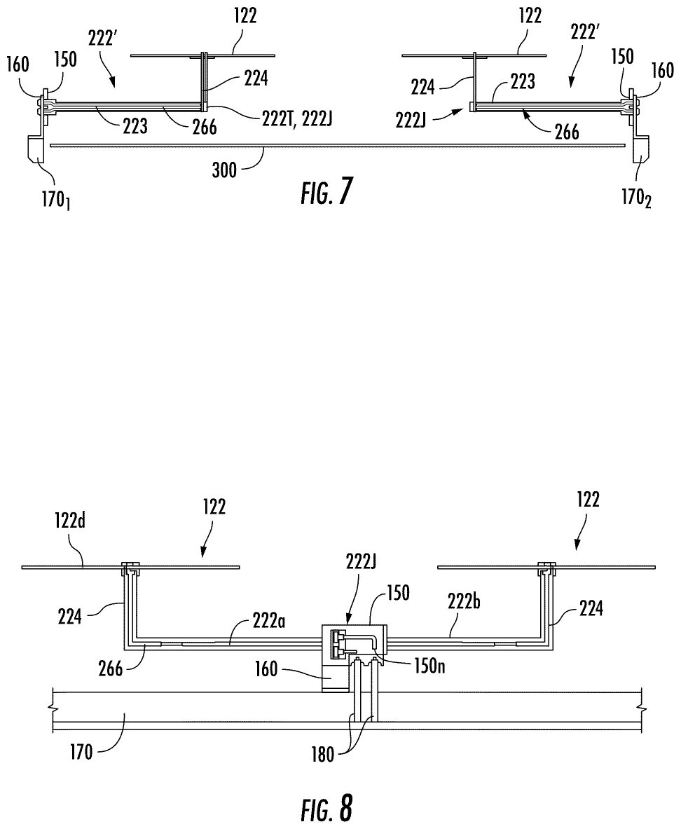

The first and second feed stalk segments 222a, 222b can be perpendicular to the first laterally inward extending portion 223 and each can extend longitudinally in opposing directions from the junction 222J for a distance then turn to project forward to provide the second leg 224 that attaches to the respective radiating element 122. When viewed from the side, as shown in FIG. 8, the feed stalk 222′ can have a “U-shape” with the vertical operational orientation (which is perpendicular to the horizontal orientation in FIG. 8) defining a long, closed end of the “U-shape” and the second leg 224 that project forward defining short sides of the “U-shape”. The first and second feed stalk segments 222a, 222b can be aligned in a vertical direction to have the same lateral extent with the junction 222J defined by a T-junction 222T with the first leg 223 of the feed stalk 222′ providing the long dimension of the “T”.

Alternatively, one of the first and second feed stalk segments 222a, 222b may extend a further lateral distance than the other so that the first and second feed stalk segments 222a, 222b extend longitudinally but are offset a distance laterally (not shown). This allows the radiating elements 122 in a linear array to be positioned in a “staggered” column. This approach can advantageously narrow the beamwidths of the antenna beams generated by the linear array in the azimuth plane.

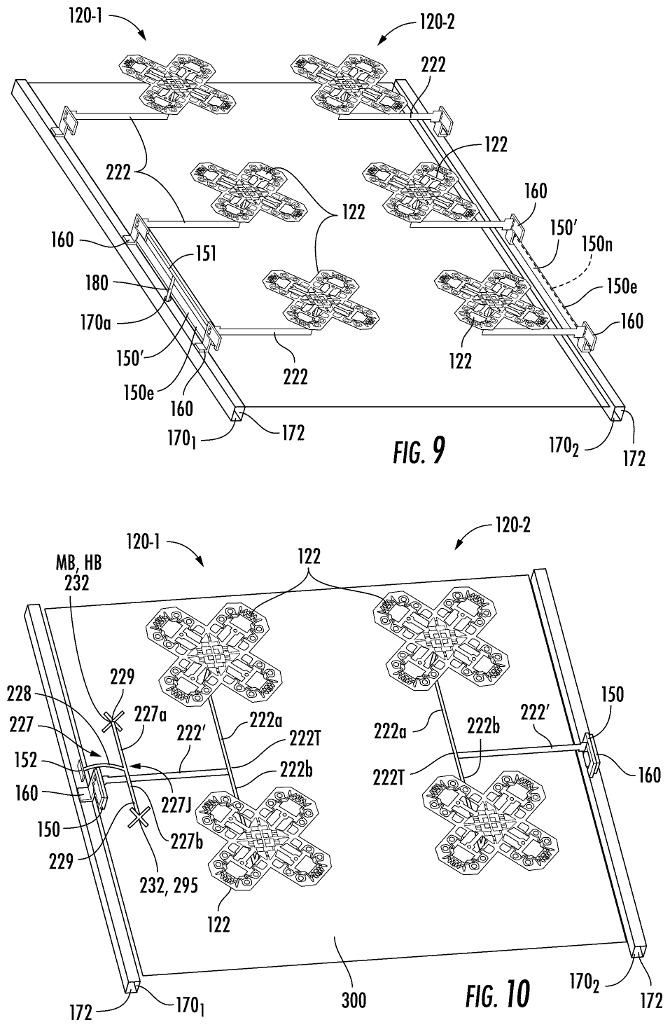

FIG. 9 illustrates that the feed board 150′ can be an elongate feed board 150 that can extend between and couple to at least two longitudinally neighboring feed stalks 222, shown as two neighboring feed stalks 222. The elongate feed board 150e can be coupled to at least one side support segment 160, shown as two longitudinally spaced apart side support segments 160. Thus, feed cables 180 can be routed through one or two apertures 170a in the longitudinally-extending support 1701, 1702 to the elongate feed board 150e. The elongate feed board 150e can include the feed network 150n with a power splitter 151.

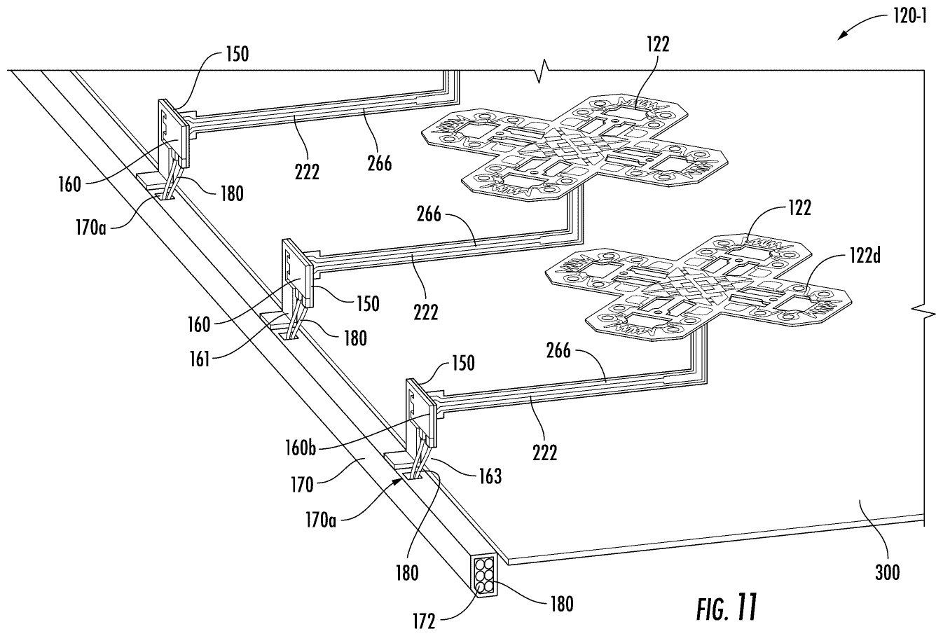

FIG. 10 schematically illustrates that a single side support segment 160 can support a single smaller feed board 150 but can still feed two radiating elements 122 via feed stalk 222′. The feed stalk 222′ is coupled to the feed board 150 and can have a junction 222J that provides the first and second feed stalk segments, 222a, 222b, as discussed above.

FIG. 10 also shows that additional radiating elements such a mid-band 232 or high-band 295 radiating elements, which can operate in a different operating band than the radiating elements 122 and can be positioned between the respective longitudinally-extending support 1701, 1702 and closest array of radiating elements 120-1, 120-2. The additional radiating elements 232 or 295 can be coupled to a feed board 152 that can either extend from the side support segment 160 or may be held in front of or behind substrate 300, parallel to the substrate 300. As shown, a single feed stalk 227 can extend in front of (or, alternatively, behind) feed stalk 222′, longitudinally aligned with feed stalk 222′. The feed stalk 227 can have a similar configuration as the feed stalk 222′, with a first leg 228 extending from the feed board 152 and splitting at a junction 227J into first and second leg segments 227a, 227b, then merging into the forwardly projecting second leg 229 coupled to the radiating element 232 or 295. The feed board 152 can be longitudinally offset from the feed board 150 but both can be attached to a common side support segment 160.

Turning again to FIG. 11, the side support segment 160 can have a forward portion 160b that has a greater longitudinal length than a rearward portion 161 attached to the longitudinally-extending support 170. The longitudinally-extending support aperture 170a can reside under the forward portion 160b with the feed cables 180 extending in an open space 163 behind the forward portion 160f.

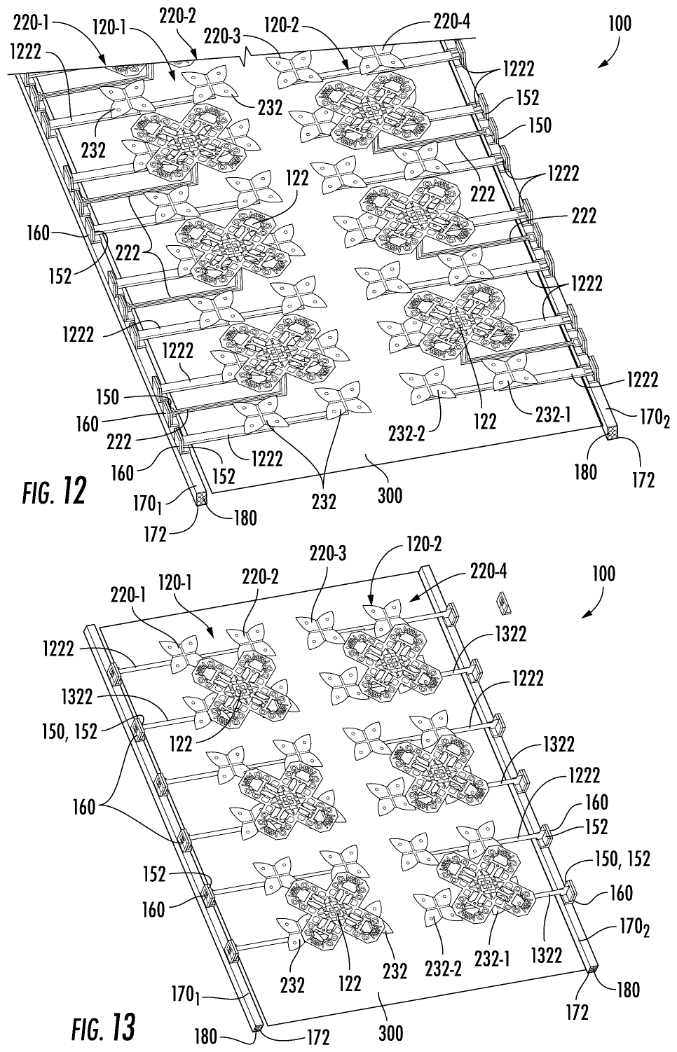

Referring to FIG. 12, another example configuration of a base station antenna is shown with first and second arrays 120-1, 120-2 of radiating elements 122 and with first through fourth arrays 220-1, 220-2, 220-3, 220-4 of second radiating elements 232. The second radiating elements 232 can be configured so that one feed stalk 1222 extends laterally inward from a side support segment 160 and/or a feed board 152 and feeds laterally spaced apart first and second radiating elements 232-1, 232-2. The feed stalks 1222 can transition from a region that is wider or thicker in at least one dimension, typically in the Z dimension to a thinner region 1223 that is positioned to be laterally inward from the side wall 100s and the first radiating element 232-1. The Z dimension corresponds to a front to back direction of the base station antenna 100 in a Cartesian XYZ coordinate system. The Y dimension refers to the longitudinal direction and the X dimension refers to the lateral direction.

The radiating elements 122 can be configured so that one feed stalk 222 feeds one radiating element 122 and so that separate feed stalks 222 can feed the respective radiating elements 122 of the first array 120-1 of the radiating elements 122 such that the feed stalks 222 are longitudinally spaced apart from the feed stalks 1222.

The first linear array 120-1 of first radiating elements 122 can be configured so that the feed stalks 222 position the radiating element 222 at least partially between and in front of first and second linear arrays 220-1, 220-2 of radiating elements 232. For example, the first radiating elements 122 of the first array 120-1 of radiating elements 122 can reside in front of and at least partially overlap laterally neighboring radiating elements 232 of the first and second arrays 220-1, 220-2 of the second radiating elements 232.

Referring to FIG. 13, another example configuration of a base station antenna 100 is shown with first and second arrays 120-1, 120-2 of first radiating elements 122 and with first through fourth arrays 220-1, 220-2, 220-3, 220-4 of the second radiating elements 232. The second radiating elements 232 can be configured so that alternating rows of the second radiating elements 232 have one feed stalk 1222 that extends laterally inward from a side support segment 160 and/or a feed board 152 and feeds laterally spaced apart first and second radiating elements 232-1, 232-2. Between the feed stalks 1222 in alternating rows, feed stalks 1322 can feed the first radiating element 122 of the first or second array 120-1 and the first and second radiating elements 231-1, 231-2 of the first and second arrays 220-1, 220- or of the third and fourth arrays 220-3, 220-4. Compared to FIG. 12, there may be less signal blockage due to less feed stalk structure provided by this arrangement.

Alternatively, separate feed stalks 222 from the feed stalks 1222 can be longitudinally aligned with the underlying feed stalks 1222 in the alternating rows to feed the radiating elements 122, so that the feature identified as feed stalk 1322 in FIG. 13 can be provided as two separate aligned feed stalks 222, 1222.

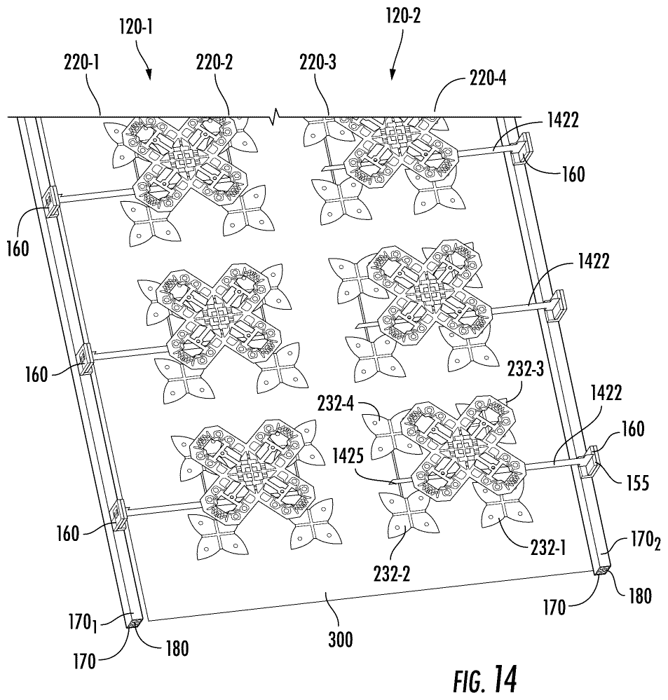

FIG. 14 illustrates that a feed stalk 1422 can be coupled to a side support segment 160 and can be configured to feed a first radiating element 122 of the first array 120-1 or the second array 120-2 of first radiating elements 122 and also feed a plurality (shown as four, 232-1, 232-2, 232-3, 232-4) of second radiating elements 232 of two different laterally adjacent arrays 220-2, 220-4 or 220-1, 220-2. The feed stalk 1422 can be coupled to at least one feed board 150 and 152 or 155 and can comprise or be coupled to a power divider 1425 that directs power to respective second radiating elements 232-1, 232-2, 232-3, 232-4 to provide the electrical path from the feed board 155.

Two outputs of the power divider 1425 can be positioned just at a center of the adjacent pairs of radiating elements 232-1, 232-2, or 232-3, 232-4. The height of the vertical part (in the orientation shown) depends on the height of the radiating elements 232-1, 232-2, 232-3, 232-4. The power divider 1425 can be positioned between the feed stalk arm 1422 and the FSS 300. In the embodiment shown, there are two power dividers, one for the first pair of radiating elements 232-1, 232-2, and another for a second pair of radiating elements 232-3, 232-4. The power divider(s) 1425 function is similar to the feed board of conventional antenna and connects the two dipoles acting as a pair to one phase shifter output.

The first radiating elements 122 can be low band dipole radiating elements 122d. The second radiating elements 232 can be mid-band radiating elements and can reside behind the low band radiating elements 122. The dipole arms 122d of a respective the low-band radiating element 122 can overlap with parts of four neighboring second radiating elements 232-1, 232-2, 232-3, 232-4.

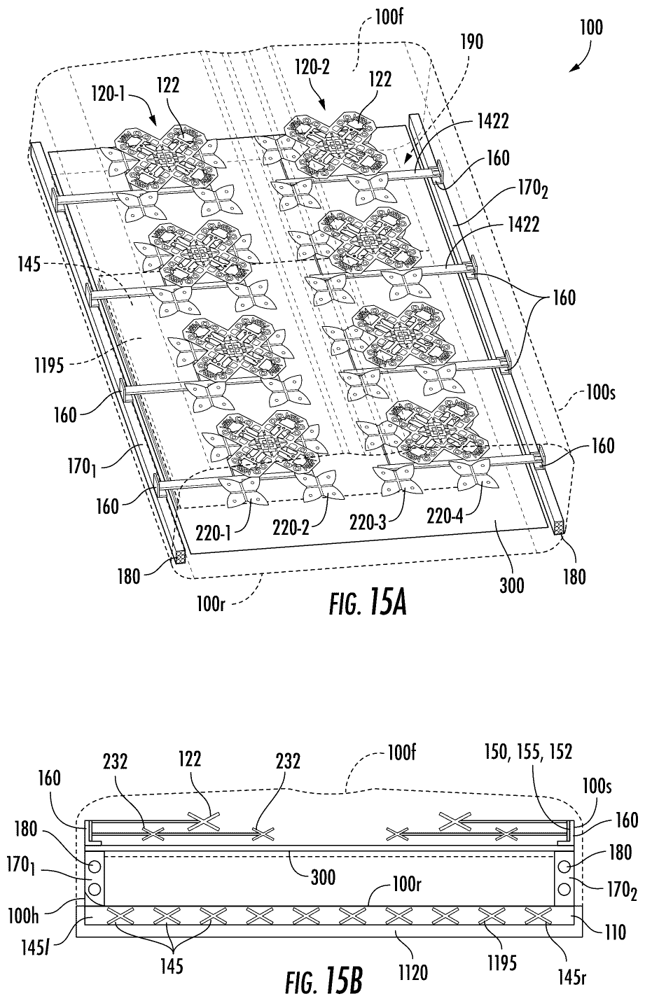

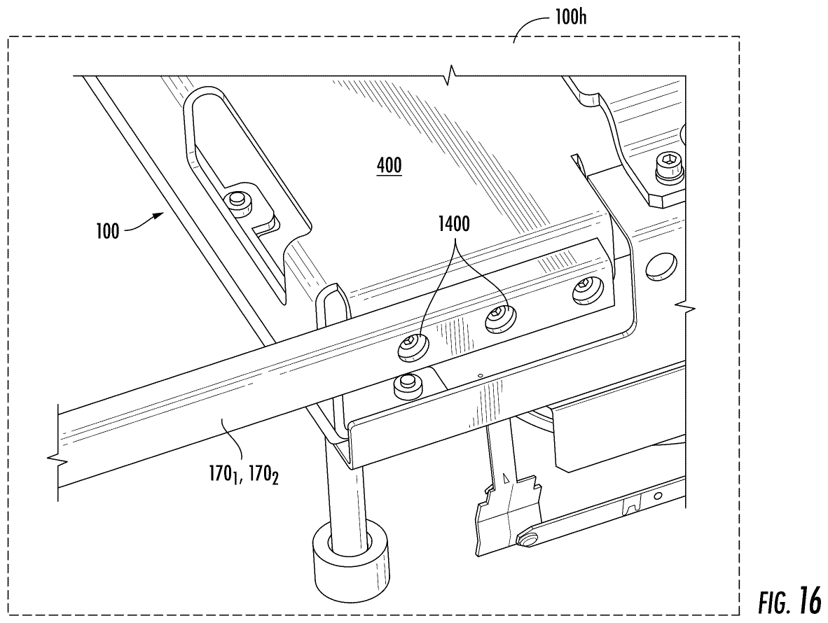

Referring to FIG. 15A, a partial perspective simplified view of a base station antenna 100 is shown with a massive multiple input multiple output mMIMO array 1195 positioned behind the first and second arrays of first radiating elements 122 and the arrays 220 of the second radiating elements 232, also behind the substrate 300, and typically behind a rear (radome) 100r. All of the above-described embodiments may have a mMIMO array 1195 positioned behind the substrate 300.

Turning to FIG. 15B, a schematic illustration shows that the mMIMO array 1195 can be provided in an active antenna module 110 that is positioned behind the housing 100h providing the passive antenna 190 of the base station antenna 100. The term “active antenna module” is used interchangeably with “active antenna unit” and “AAU” and “active antenna” and refers to a cellular communications unit comprising radio circuitry 1120 and associated radiating elements 145. The radio circuitry 1120 is capable of electronically adjusting the amplitude and/or phase of the subcomponents of an RF signal that are output to different radiating elements of an array or groups thereof. The active antenna module 110 comprises the radio circuitry 1120 and the radiating elements 145/1195 (e.g., a multi-input-multi-output (mMIMO) beamforming antenna array) and may include other components such as filters, a calibration network, an antenna interface signal group (AISG) controller and the like. The active antenna module 110 can be provided as a single integrated unit or provided as a plurality of stackable units, including, for example, first and second sub-units such as a radio sub-unit (box) with the radio circuitry and an antenna sub-unit (box) with a multi-column array of radiating elements and the first and second sub-units stackably attach together in a front to back direction of the base station antenna 100, with the radiating elements closer to the rear 100r of the housing 100h of the base station antenna 100 than the radio circuitry unit 1120. In some embodiments, the radiating elements 1195 may comprise a separate sub-unit from the radio circuitry and the radiating element sub-unit may be mounted within the base station antenna 100 instead of being external to the base station antenna 100.

The base station antenna 100 includes an antenna assembly 190, which can be referred to as a “passive antenna assembly”. The arrays of radiating elements included in the passive antenna assembly 190 are configured to form static antenna beams (e.g., antenna beams that are each configured to cover a sector of a base station). The passive antenna assembly 190 can comprise one or more linear arrays 120-1, 120-2 of low band radiating elements 122 that operate in all or part of the 617-960 MHz frequency band and/or one or more linear arrays 220-1-220-4 of mid-band radiating elements 232 that operate in all or part of the 1427-2690 MHz frequency band. The passive antenna assembly 190 is mounted in the housing 100h of base station antenna 100 and one or more active antenna modules 110 can releasably (detachably) couple (e.g., directly or indirectly attach) to base station antenna 100.

The housing 100h may be substantially rectangular with a flat rectangular cross-section. The housing 100h may be provided to define at least part of a radome with at least the front side 100f configured as a dielectric cover that allows RF energy to pass through in certain frequency bands. The housing 100h may also be configured to that the rear 100r defines a rear side radome opposite the front side radome 100f. The two (narrow) side walls 100s can form part of the radome.

Radiating elements 145 of the massive MIMO array 1195 can be arranged in vertical columns as is well known to those of skill in the art. Due to the configuration of the feed stalks 222, 1222, 1322, 1422 discussed above, at least one column 145r of radiating elements 145 on a right side of the base station antenna 100 and at least one column 145l of radiating elements 145 on the left side of the base station antenna 100 can be positioned to be laterally between, but behind, a linear array 220-1, 220-4 of mid-band radiating elements 232 and the adjacent side wall 100s.

The linear arrays 120-1, 120-2 can include low-band radiating elements 122 according to embodiments of the present invention. The low-band radiating elements 122 may comprise cross-dipole radiating elements that include a total of four dipole arms 122a. The low-band radiating elements 122 may be cloaked low-band radiating elements that are configured to be substantially transparent to RF energy in the operating frequency band of the massive MIMO array. An example of a known cloaked dual-polarized low-band radiating element is disclosed in U.S. Patent Publication No. 2018/0323513 (“the '513 publication”), filed Feb. 15, 2018, the entire content of which is incorporated herein by reference.

The first and second dipole radiator arms 122a may be configured to transmit RF radiation having slant −45° and slant +45° polarization. These radiating elements 122 may be particularly well-suited for use in base station antennas that have a multi-column array of radiating elements 145 that operate in a higher frequency band than the radiating elements 122 according to embodiments of the present invention.

The high-band radiating elements 145 can be mounted in columns, typically two or four columns, to form a plurality of linear arrays of high-band radiating elements. The mMIMO or multi-column array 1195 can provide high-band radiating elements 145 that may be configured to transmit and receive signals in a higher frequency band such as, for example, the 3300-4200 MHz frequency range or a portion thereof or even higher frequency (typically in a 3 GHZ-6 GHz range).

The radiating element 122 generates both slant −45° and slant +45° radiation and is typically called a “cross-dipole” radiating element as it includes two dipole radiators that form a cross shape when viewed from the front.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

“About” with respect to the numbers and angles described herein refers to +/−10 degrees thereof and the term “substantially parallel” refers to +/−10 degrees from parallel.

Aspects and elements of all of the embodiments disclosed above can be combined in any way and/or combination with aspects or elements of other embodiments to provide a plurality of additional embodiments.

1. A base station antenna, comprising:
a longitudinally-extending support;
a plurality of side support segments that are longitudinally spaced apart and that extend forwardly from the longitudinally-extending support; and
a plurality of radiating elements, at least some of which are mounted to one or more of the plurality of side support segments.

2. The base station antenna of claim 1, wherein the longitudinally-extending support is provided as a first longitudinally extending support positioned to extend along a first side wall of a housing enclosing the plurality of radiating elements and a second longitudinally extending support-extending support positioned to extend along a laterally spaced apart second side wall of the housing.

3. The base station antenna of claim 1, wherein the plurality of side support segments each have a wall that is perpendicular to a reflector or frequency selective surface positioned behind the plurality of radiating elements, wherein the plurality of side support segments are attached to the longitudinally-extending support, and wherein the base station antenna further comprises a plurality of feed boards arranged so that at least one feed board of the plurality of feed boards is parallel to and mounted to at least one of the plurality of side support segments.

4. The base station antenna of claim 1, wherein the plurality of radiating elements comprise a first vertically-extending column of first radiating elements, at least some of which are mounted to one of the plurality of side support segments or to more than one but a subset of the plurality of side support segments.

5. The base station antenna of claim 2, wherein the plurality of side support segments are provided as a plurality of first side support segments extending along the first side wall of the housing and a plurality of second side support segments extending along the second side wall of the housing, wherein the plurality of radiating elements comprise a first vertically-extending column of first radiating elements, at least some of which are mounted to one or more of the first side support segments, and a second vertically-extending column of first radiating elements, at least some of which are mounted to one or more of the second side support segments.

6. The base station antenna of claim 1, wherein the plurality of radiating elements each comprise a feed stalk, wherein the feed stalk comprises a first leg and a second leg, wherein the first leg attaches to at least one of the side support segments and extends laterally inward from the at least one side support segment, wherein the second leg is orthogonal to the first leg and extends forward of the first leg to attach to dipole radiators of a corresponding radiating element at a position in the base station antenna that is forward of the first leg.

7. (canceled)

8. The base station antenna of claim 1, wherein the longitudinally-extending support has a channel that extends in a longitudinal direction, and wherein the base station antenna further comprises feed cables that extend in the channel.

9. The base station antenna of claim 8, wherein the longitudinally-extending support has an outer wall surrounding the channel, wherein the outer wall comprises a plurality of apertures that are longitudinally spaced apart, wherein at least one aperture of the plurality of apertures of the outer wall is adjacent at least one of the side support segments, wherein at least one feed cable of the feed cables in the channel and is routed out of one of the plurality of apertures to extend forward of the longitudinally-extending support and connects to at least one radiating element of the plurality of radiating elements.

10. The base station antenna of claim 1, wherein at least one feed cable is connected to a feed board held by one or more of the side support segments, and wherein the feed board is perpendicular to a primary reflector coupled to the longitudinally-extending support.

11. The base station antenna of claim 8, wherein the feed cables are coaxial feed cables, and wherein an outer conductor of the coaxial feed cables is electrically grounded to the longitudinally-extending support.

12. The base station antenna of claim 1, further comprising:
a substrate in the housing comprising a frequency selective surface residing behind at least some of the plurality of radiating elements; and
a primary reflector in the housing attached to the longitudinally-extending support.

13. The base station antenna of claim 12, wherein the substrate comprises at least one matching layer or the substrate is adjacent at least one matching layer.

14. The base station antenna of claim 1, wherein neighboring pairs of at least some of the side support segments are spaced apart a distance greater than a length of the side support segments, the length measured in a longitudinal direction of the base station antenna.

15. The base station antenna of claim 1, wherein the plurality of radiating elements comprise cross-dipole radiating elements, wherein each cross-dipole radiating element has first and second dipole radiators provided by a printed circuit board, wherein a feed stalk is attached to the first and second dipole radiators and resides behind the printed circuit board, wherein the feed stalk has a first leg that extends laterally inward from one or more of the side support segments, then turns 90 degrees to project forward from the first leg adjacent the printed circuit board.

16. The base station antenna of claim 6, wherein the feed stalk is a single feed stalk body that provides both a ground path and microstrip transmission line.

17. The base station antenna of claim 1, wherein at least some of the plurality of radiating elements each comprise a feed stalk that has a first leg that attaches to at least one of the side support segments the first leg extends laterally inward and merges into first and second intermediate segments that extend longitudinally in opposing directions then merge into a respective second leg of the feed stalk, wherein the respective second leg of the feed stalk is orthogonal to the first leg and extends in a front to back direction of the base station antenna, forward of the first leg to attach to a respective radiating element forward of the first leg.

18-20. (canceled)

21. The base station antenna of claim 1, further comprising a feed stalk that feeds first and second dual polarized radiating elements of the plurality of radiating elements, wherein the feed stalk is mounted to one or more of the side support segments.

22-24. (canceled)

25. The base station antenna of claim 5, wherein the plurality of radiating elements further comprise:
a first vertically-extending column of second radiating elements, at least some of which are mounted to one or more of the first side support segments;
a second vertically-extending column of second radiating elements, at least some of which are mounted to one or more of the second side support segments,
a third vertically-extending column of the second radiating elements, at least some of which are mounted to one or more of the first side support segments; and
a fourth vertically-extending column of the second radiating elements, at least some of which are mounted to one or more of the second side support segments,
wherein at least some of the second radiating elements reside closer to the first side support segments than the first radiating elements that are mounted to one or more of the first side support segments.

26. The base station antenna of claim 25, wherein a second radiating element of the first vertically-extending column of second radiating elements and a second radiating element of the second vertically-extending column of second radiating elements share a feed stalk that extends laterally inward from the one or more of the first side support segments, and wherein a second radiating element of the third column of second radiating elements and a second radiating element of the fourth column of second radiating elements share a feed stalk that extends laterally inward from one or more of the second side support segments.

27-35. (canceled)

36. A base station antenna comprising:
a feed stalk that comprises a first leg that projects laterally inward a first distance and feeds first and second dipole radiators of a first radiating element as well as third and fourth dipole radiators of a second radiating element.

37-42. (canceled)

43. A base station antenna, comprising:
a plurality of side support segments that are longitudinally spaced apart and coupled to a longitudinally extending support;
a reflector;
a plurality of radiating elements, at least some of which reside in front of the reflector; and
feed boards that are coupled to one or more of the side support segments and feed the plurality of radiating elements,
wherein the feed boards are perpendicular to a primary surface of the reflector and/or a primary surface of a frequency selective surface behind the plurality of radiating elements.

44-46. (canceled)
